(19) United States
(12) Patent Application Publication
(10) Pub. No.: US 2005/0227046 A1
(43) Pub. Date: Oct. 13, 2005

(54) Glass shard-paved structure

(76) Inventor: Joe Lee, Taichung Hsien (TW)

Correspondence Address: BRINKS HOFER GILSON & LIONE;NBC Tower, Suite 3600, 455 N. Cityfront Plaza Drive, Chicago, IL, 60611-5599, US

(21) Appl. No.: 10/821,498

(22) Filed: Apr. 9, 2004

(51) Int. Cl. B32B 1/00

(52) U.S. Cl. 428/143

(57) ABSTRACT

A glass shard-paved structure includes a substrate having an outer surface, and a plurality of glass shards bonded to the outer surface of the substrate so as to form a glass pattern on the substrate. The glass shards are formed by mixing raw glass shards with carbon powders so as to permit adhesion of the carbon powders to the surface of each of the raw glass shards, heating the raw glass shards so as to melt the surface of each of the raw glass shards, cooling the heated glass shards, and removing the carbon powders from the glass shards.

### BACKGROUND OF THE INVENTION

1. Field of the Invention

This invention relates to a glass shard-paved structure, more particularly to a glass shard-paved structure having a glittering appearance.

2. Description of the Related Art

In general, the appearance of a structure, such as roadblocks, wall decorations, tables and tiles, etc., can be enhanced by decoration. For example, the decorations can be light-reflective stickers adhered to a roadblock or drawings painted on a wall, a table, or a tile. However, the stickers or other decorative items adhered to the structure tend to wrinkle or peel off due to repeated expansion and contraction as a result of temperature change. In addition, the stickers adhered to the roadblocks or the patterns formed on the wall decorations are two-dimensional, not three-dimensional, and lack a glittering effect.

### SUMMARY OF THE INVENTION

Therefore, the object of this invention is to provide a glass shard-paved structure with glass shards bonded to a substrate so as to form a glass pattern. Each of the glass shards has an irregular shape and facets that impart a glittering appearance to the glass shard-paved structure.

According to this invention, a glass shard-paved structure includes a substrate having an outer surface, and a plurality of glass shards bonded to the outer surface of the substrate so as to form a glass pattern on the substrate. The glass shards are manufactured by the steps of: (a) mixing raw glass shards with carbon powders so as to permit adhesion of the carbon powders to the surface of each raw glass shard; (b) heating the raw glass shards so as to melt the surface of each raw glass shard; (c) cooling the heated glass shards; and (d) removing the carbon powders from the glass shards. Each of the glass shards thus formed has an irregular shape and facets that impart a glittering effect to the glass shard-paved structure.

### BRIEF DESCRIPTION OF THE DRAWINGS

Other features and advantages of the present invention will become apparent in the following detailed description of the preferred embodiments of the invention, with reference to the accompanying drawings. In the drawings:

FIG. 1 is a schematic cross-sectional view to illustrate the first preferred embodiment of a glass shard-paved structure according to this invention;

FIG. 2 is a schematic cross-sectional view to illustrate the second preferred embodiment of a glass shard-paved structure according to this invention;

FIG. 3 is a schematic view to illustrate application of the first preferred embodiment of FIG. 1 to a roadblock;

FIG. 4 is a schematic view to illustrate application of the first preferred embodiment of FIG. 1 to a wall decoration;

FIG. 5 is a schematic view to illustrate application of the first preferred embodiment of FIG. 1 to a tile; and

FIG. 6 is a schematic view to illustrate application of the first preferred embodiment of FIG. 1 to an ornament including stacked artificial turtles.

### DETAILED DESCRIPTION OF THE PREFERRED EMBODIMENTS

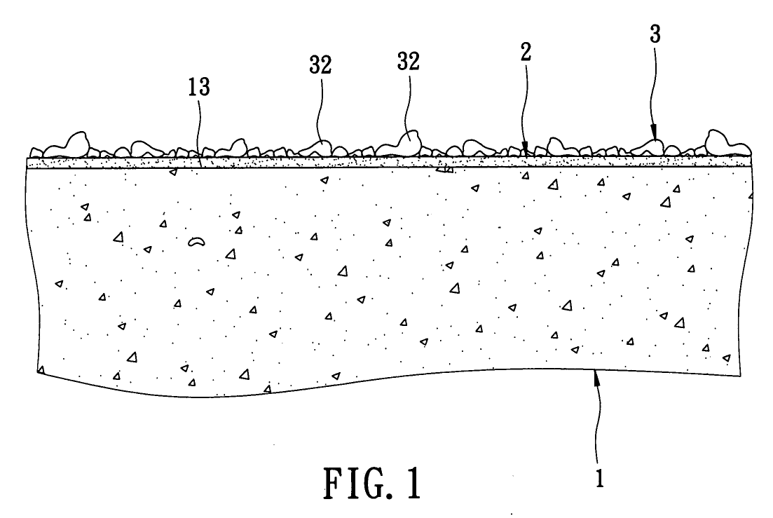

Referring to FIG. 1, the first preferred embodiment of a glass shard-paved structure according to this invention includes a substrate 1 having an outer surface 13, an adhesive layer 2 applied to the outer surface 13 of the substrate 1, and a plurality of glass shards 32 bonded to the outer surface 13 of the substrate 1 through the adhesive layer 2 so as to form a glass pattern 3 on the substrate 1. Preferably, the adhesive layer 2 is made from a material selected from the group consisting of resins, glues and cement.

In this embodiment, the adhesive layer 2 is made from cement. The glass shards 32 are bonded to the outer surface 13 of the substrate 1 by coating the latter with the cement, attaching the glass shards to the outer surface 13 of the substrate 1, and removing residual cement on outer surfaces of the glass shards 32.

The glass shards 32 are manufactured by the steps of: (a) mixing raw glass shards 32 with carbon powders so as to permit adhesion of the carbon powders to the surface of each raw glass shard 32; (b) heating the raw glass shards 32 so as to melt the surface of each raw glass shard 32; (c) cooling the heated glass shards 32; and (d) removing the carbon powders from the glass shards 32. Each of the glass shards 32 thus formed in this embodiment has an irregular shape and facets that impart a glittering effect to the glass shard-paved structure.

It is noted that the carbon powders have a function of separating the glass shards 32 from each other so as to prevent fusion of the glass shards 32. In addition, removal of the carbon powders from the glass shards 32 can be conducted by screening techniques. After removal of the carbon powders, the glass shards 32 may be optionally post-treated through cleaning. Preferably, the glass shards 32 are obtained from waste glass.

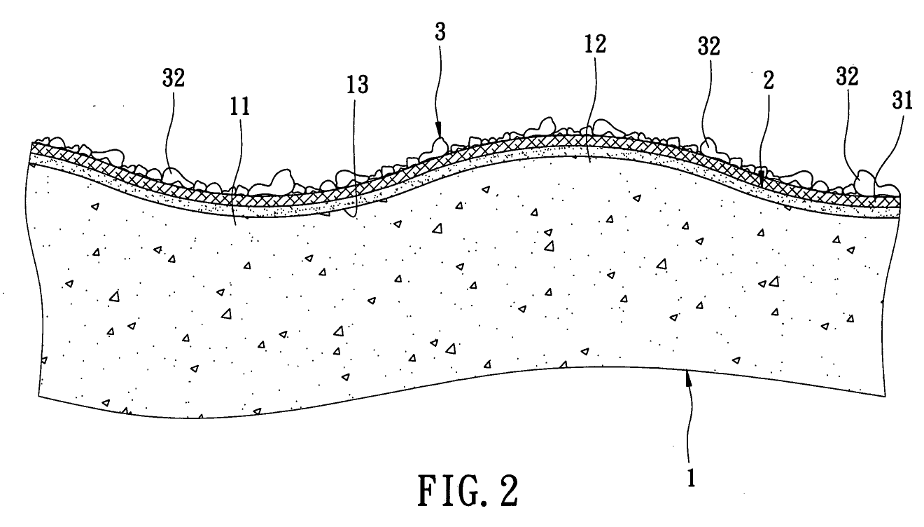

The second preferred embodiment of the glass shard-paved structure according to this invention is shown in FIG. 2 to have a structure similar to that of the first embodiment shown in FIG. 1, except for the inclusion of an additional fabric web 31. In this embodiment, the outer surface 13 of the substrate 1 includes concave portions 11 and convex portions 12. The adhesive layer 2 is applied to the outer surface 13 of the substrate 1. The fabric web 31 is bonded and conforms to the outer surface 13 of the substrate 1 through the adhesive layer 2. The glass shards 32 are fixed to the fabric web 31 so as to form the glass pattern 3.

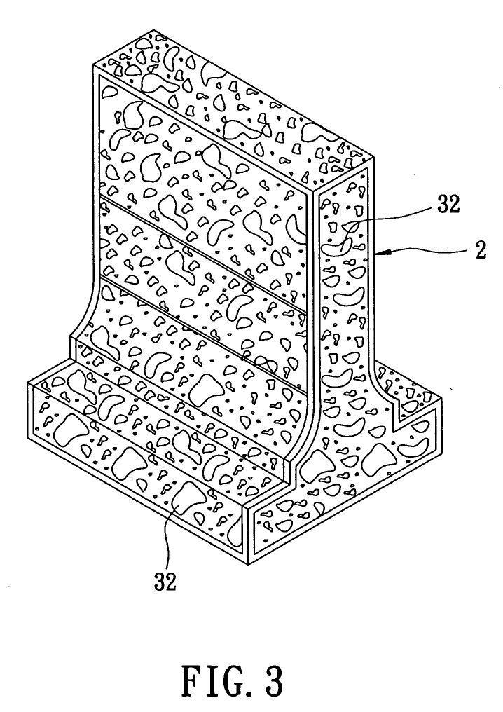

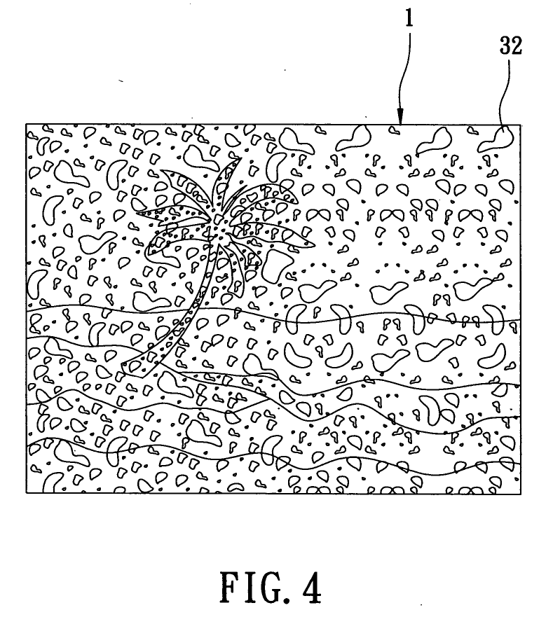

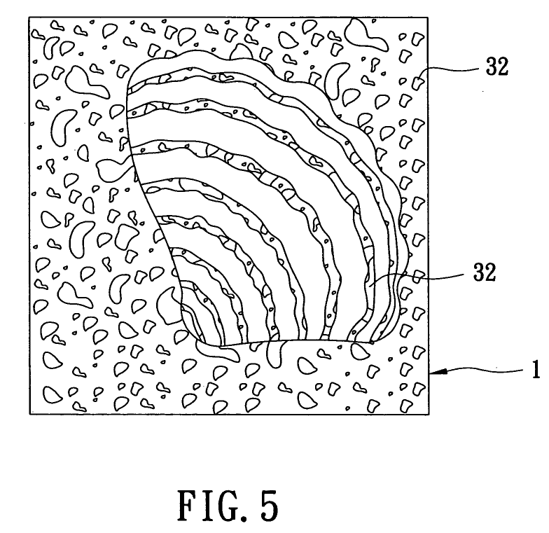

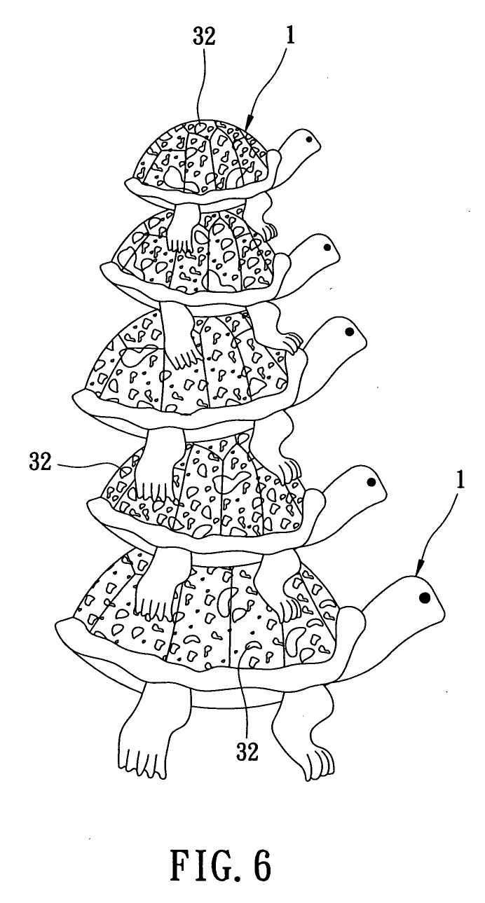

The structural design of the glass shard-paved structure according to this invention can be utilized in various construction items or decorative applications. FIG. 3 illustrates application of the structural design of the glass shard-paved structure according to this invention to a roadblock. FIG. 4 illustrates application of the structural design of the glass shard-paved structure according to this invention to a wall decoration. FIG. 5 illustrates application of the structural design of the glass shard-paved structure according to this invention to a tile. FIG. 6 illustrates application of the structural design of the glass shard-paved structure according to this invention to an ornament including stacked artificial turtles.

Since each of the glass shards 32 on the glass shard-paved structure of this invention has a plurality of light-reflecting facets, the glass shards 32 exhibit a glittering appearance. The glass shards 32 may have different colors so as to form a colorful and stereometric glass pattern 3 on the substrate 1 and so as to increase the consumer appeal of the glass shard-paved structure. In addition, by virtue of the physical and chemical properties of glass, the glass shard-paved structure of this invention has advantages of thermal stability, resistance to wear, anti-moisture, and anti-dust.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A glass shard-paved structure, comprising
a substrate having an outer surface; and
a plurality of glass shards bonded to said outer surface of said substrate so as to form a glass pattern on said substrate;
wherein said glass shards are manufactured by the steps of:
(a) mixing raw glass shards with carbon powders so as to permit adhesion of said carbon powders to the surface of each of said raw glass shards;
(b) heating said raw glass shards so as to melt the surface of each of said raw glass shards;
(c) cooling said heated glass shards; and
(d) removing said carbon powders from said glass shards;
wherein each of said glass shards thus formed has an irregular shape and facets that impart a glittering effect to said glass shard-paved structure.

2. The glass shard-paved structure according to claim 1, further comprising an adhesive layer, said glass shards being bonded to said substrate through said adhesive layer, said adhesive layer being made from a material selected from the group consisting of resins, glues and cement.

3. The glass shard-paved structure according to claim 1, further comprising an adhesive layer and a fabric web, said fabric web being bonded to said substrate through said adhesive layer, said glass shards being fixed to said fabric web.
